(19) United States
(12) Patent Application Publication
(10) Pub. No.: US 2026/0305577 A1
(43) Pub. Date: Oct. 8, 2026

(54) A LEAD AND COLLAR ASSEMBLY FOR A PET

(71) Applicant: BONDI PEAK PTY LTD, Tamarama (AU)

(72) Inventors: Sarah COSTIN, Tamarama (AU); Danuta GRALIK, Caves Beach (AU); Christian TUCKER, Abbotsford (AU); Hayden ZYLBERBERG, Abbotsford (AU); Harry HOLDEN, Abbotsford (AU); Michael DENHAM, Abbotsford (AU); Sebastian DAMM, Abbotsford (AU)

(21) Appl. No.: 19/482,401

(22) PCT Filed: May 8, 2024
(86) PCT No.: PCT/AU2024/050450

§ 371 Date: Nov. 7, 2025

(30) Foreign Application Priority Data
May 9, 2023 (AU) 2023901402

(51) Int. Cl. A01K 27/00

(52) U.S. Cl. CPC A01K 27/005; A01K 27/001; A01K 27/003

(57) ABSTRACT

A lead assembly for a pet comprises a n elongate flexible member having a distal end and a proximal end, a collar attachment member, and a lead attachment member The collar attachment member includes a collar member body connected to the distal end of the elongate flexible member and a hook and jaw assembly supported by the body and configured to releasably attach the lead assembly to a collar. The collar attachment member also includes an attachment point located thereon. The lead attachment member includes a lead member body connected to the proximal end of the elongate flexible member and a lockable connector configured for lockable attachment to the attachment point of the collar attachment member, thereby preventing the collar attachment member from being released from the collar. The attachment point of the collar attachment member is located on a jaw member of the hook and jaw assembly. Attaching the lead attachment member to the attachment point substantially precludes movement of the jaw member relative to the body and locks the jaw member into the closed condition relative to the body.

### CROSS-REFERENCE TO RELATED APPLICATIONS

The present application is a national phase application under 35 U.S.C. 371 of International Application No. PCT/AU2024/050450 filed May 8, 2024, which claims the benefit of and priority to Australian Provisional Patent Application No 2023901402 filed on May 9, 2023, the contents of both of which being incorporated by reference in their entireties herein.

### TECHNICAL FIELD

The present disclosure broadly relates to a lead assembly and a collar assembly for a pet, and also to a safety assembly comprising a lead and collar for securing a pet.

### BACKGROUND

Pet ownership and walking pets has been increasingly popular as a healthy active option for both the owner and pet. Since pets are not allowed into various establishments, pet owners may sometimes need to leave their pets outside unattended. Owners often use their pet's lead or leash to tie up a pet to a lamp post, a fence, or similar anchor point. One way of doing this is to temporarily remove the lead from the collar, thread the clasp of the lead through the handle of the lead, and then reattach the lead to the collar. This can be cumbersome and fiddly, and the pet is generally not very secure during the process and could pull free and run away while the owner is using both hands to attach the lead to the anchor point.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

### BRIEF SUMMARY

While most owners simply secure their pet to a post or other fixed object by tying a knot in the lead, or looping the lead through itself, it is relatively simple for a thief to unclip the lead from the collar or untie the lead from the post. Unfortunately, in recent years, the theft of pets, and especially dogs, has increased dramatically. Fear of dog theft may discourage owners from leaving their pet unattended for any length of time.

Some attempts have been made to provide collars or leads with improved security so that the pet may be securely locked to the post without fear of theft. For instance, dog collars with a buckle clip closure having a key lock or a combination lock on the buckle clip are available which prevent the collar from being removed from the dog. For instance, dog leads may be locked with a shackle or other locking device to the collar of the dog to prevent the lead from being removed from the collar, while dog chains may be locked back onto the chain with a locking device to prevent the lead from being removed from a post. Wire embedded collars and leads may also reduce the risk of thieves cutting the collars or leads in order to steal the pet while pet monitoring systems may be used to monitor or track a pet or activate an alarm if the lead or collar is tampered with.

Lead assemblies and collar assemblies which provide improved security and reduce the risk of theft of a pet are desirable.

In a first aspect, there is provided a lead assembly for a pet, the lead assembly comprising:
an elongate flexible member having a distal end and a proximal end;
a collar attachment member having:
   a first body connected to the distal end of the elongate flexible member, and
   a hook and jaw assembly supported by the first body and configured to releasably attach the lead assembly to a collar, the collar attachment member having an attachment point located thereon, and
a lead attachment member having:
   a second body connected to the proximal end of the elongate flexible member and
   a lockable connector supported by the second body and configured for lockable attachment to the attachment point of the collar attachment member, thereby preventing the collar attachment member from being released from the collar.

While the present application refers to attaching the lead assembly to a “collar”, the person skilled in the art will appreciate that the collar attachment member may be used to attach the lead assembly to any other suitable tether and/or restraint for a pet such as a bridle, a halter, a harness, or the like.

While the present application refers to a “lead” assembly, the person skilled in the art will appreciate that this term is also intended to mean a “leash” assembly.

Advantageously, the present disclosure provides improved security for pet owners by allowing the lead to be looped around an immovable object and connected to the lead in a way that prevents the lead being removed from the collar, and/or the collar being removed from the pet and/or adjusted without the key.

The lead assembly may be adapted for a variety of pets. For instance, the lead assembly may be for a domestic animal such as a dog, a cat, a ferret, a rat, or the like, or for a livestock animal such as horses, cattle, sheep, goats, alpacas, or the like. In some embodiments described herein, the lead assembly may be for a dog.

The elongate flexible member has a distal end and a proximal end. The distal end of the elongate flexible member may be adapted for connection to a collar and the proximal end of the elongate flexible member may be adapted for connection to a lead.

The elongate flexible member may have a generally uniform cross-section along its length. The cross section may be substantially circular, oval, or oblong in shape.

The elongate flexible member may be fabricated from any material sufficient to provide a light, flexible but strong lead. For instance, the elongate flexible member may be fabricated from a metal or metal alloy such as steel, aluminium, or the like, a polymeric material such as polypropylene, polyethylene, nylon or the like, a natural material such as leather, hemp, bamboo, a woven fabric, or any suitable combinations thereof.

The elongate flexible material may be fabricated from two or more materials. The materials may be of the same type, or of different types. The materials may have the same properties, or have different properties. For instance, the materials may be relatively resistant to cutting, may be aesthetically pleasing, may be non-abrasive, may be durable, and/or may be water-resistant.

In embodiments wherein the elongate flexible material may be fabricated from two or more materials, the materials may be in any suitable orientation relative to one another. For instance, the elongate flexible material may comprise a first material forming a core and substantially surrounded by a second material, the first material and the second material may be laminated together, the first material may be coated onto the second material, the first material and the second material may be woven together. The elongate flexible material may comprise a first material forming a core and a second material substantially surrounding the first material.

The first material forming a core may be a reinforcing material. Any reinforcing material with sufficient mechanical properties strength, rigidity, durability, etc to provide the elongate flexible member with security against cutting and/or pulling may be used. In some embodiments, the first material may be a steel wire.

The second material forming an outer layer substantially surrounding the first material may be a flexible, durable strap material, such as leather, nylon webbing, or the like. The second material may be leather.

In some embodiments, the elongate flexible member may comprise at least one embedded wire core. The at least one embedded wire core may comprise eye ends. The lead attachment member and the collar attachment member may be attached to respective ends of the elongate flexible member via an eye end. Advantageously, providing the elongate flexible member with an embedded wire core and connecting the respective attachment members to eye ends connected to the wire core adds strength and security against cutting and pulling.

The ends of the elongate flexible member may be provided with a skirt so as to reinforce the connection between the flexible member and the lead attachment and/or to prevent dirt and other debris from entering the lead attachment member and/or the collar attachment member.

The elongate flexible member may comprise at least one lead connector located along the length of the elongate flexible member. When the lead attachment member is attached to the lead connector, a loop is formed in the elongate flexible member, forming a lead handle. The lead connectors may be located in any position along the length of the elongate flexible member.

In instances where a loop is to be formed for use as a handhold, a lead connector located closer to the proximal end of the elongate flexible member may be used. In other embodiments, when the lead assembly is to be formed into a large loop and/or connected to a post, tree, or the like, the lead attachment member may be attached to a lead connector located closer to the distal end of the elongate flexible member.

The lead connector may be of any suitable size, shape and configuration sufficient to facilitate the attachment of the lead attachment member to the elongate flexible member. The lead connector may be a ring, a clamp, or the like.

The lead connector may be fixed to the elongate flexible member. The lead connector may be fixed directly to the elongate flexible member, or indirectly to the elongate flexible member via a tab, clamp, or the like. The lead connector may be stitched to, adhered to, and/or compressed about the elongate flexible member, or any suitable combination thereof.

The lead connector may comprise a tab stitched and/or adhered to the elongate flexible member and a ring mounted thereon. The lead connector may comprise a body adhered to and/or compressed about the elongate flexible member, the body comprising a loop-or ring-shaped projection extending outwardly from the body.

The collar attachment member may be of any suitable type sufficient to attach the lead assembly to a collar of an animal and to prevent the collar attachment member from being released from the collar. In some embodiments, the collar attachment member may be lockably attached to the collar. In this instance, it will be understood that a key, code or biometric profile which unlocks the lock mechanism is required to release the collar attachment member from the collar.

Any suitable collar may be used. Generally, however, the collar may comprise an elongate flexible strap, a clasp for securing respective ends of the strap to one another and one or more collar connectors such as a D-rings, loops, or the like for attachment of the collar to the lead assembly.

In some embodiments, attaching the collar attachment member or the lead attachment member to a collar connector may prevent the elongate flexible strap from being released from a clasp of the collar.

In some embodiments, the collar connector may be mounted about at least a part of the clasp of the collar. Where the collar connector is mounted on the clasp of the collar, attaching the collar attachment member or the lead attachment member to the collar connector may preclude opening of the cover relative to the housing, thereby preventing the elongate flexible strap from being released from the clasp.

When the collar attachment member or the lead attachment member is attached to the collar connector, movement of the collar connector relative to the clasp may be restricted. Movement of the collar connector relative to the clasp may be restricted by any suitable means. The collar connector may be physically sized such that when the collar attachment member is attached, positioning the collar attachment member relative to the collar connector obstructs movement of the collar connector, for example the collar attachment member may be positioned within an aperture or channel formed by the collar connector, thereby obstructing movement of the collar connector. The collar attachment member may lock the collar connector to the clasp preventing movement of the collar connector.

The collar attachment member may have a collar member body, wherein the collar member body is connected to the distal end of the elongate flexible member. The collar member body of the collar attachment member may comprise a transverse channel therethrough, the transverse channel configured to receive at least a portion of a jaw member therein.

The body of the collar attachment member may be provided with an end cap, wherein the end cap may be adapted for connection to the distal end of the elongate flexible member. The end cap may be located on the end of the body opposing the hook and jaw assembly.

The end cap of the collar attachment member may comprise a first end and an opposed second end and a bore extending at least part way through the end cap from the first end to the opposing second end. The bore may extend all of the way through the end cap of the collar attachment member from the first end to the second end thereof. Thus, it is envisaged that the bore may comprise a pair of open ends, or one open and one closed end.

The body and the end cap of the collar attachment member may be fixedly, or moveably connected to one another. The body of the collar attachment member may be movably connected to the end cap, such that the body of the collar attachment member may move relative to the elongate flexible member. The body of the collar attachment may swivel relative to the end cap. Advantageously, allowing the body of the collar attachment member to move relative to the elongate flexible member may prevent the elongate flexible member from twisting, preventing damage to the elongate flexible member.

The end cap of the collar attachment member may be adapted for connection to the elongate flexible member by any suitable means sufficient to prevent the elongate flexible member from passing out of the collar attachment member. For instance, the size of the bore in the end cap may retain the elongate flexible member in frictional engagement therewith resulting from the pressure fit of the elongate flexible member within the bore. Alternatively, the end cap may be attached to the distal end of the elongate flexible member using an adhesive. In other embodiments, the elongate flexible member may be adhered to the end cap using any suitable technique, such as a heat and/or a chemical treatment technique. Alternatively, the end cap may be attached to the distal end of the elongate flexible member using a mechanical fastener such as, but not limited to screws, nails, bolts, pins, set or grub screws, rivets, or the like, or any suitable combinations thereof. In embodiments, the end cap may be attached to the distal end of the elongate flexible member, by a locking pin inserted at least partially into a locking pin bore located in the end cap and configured to engage with the distal end of the elongate flexible member. In some embodiments, the locking pin may engage with an eye end of an embedded wire core of the elongate flexible member.

The collar attachment member may have a hook and jaw assembly configured to releasably attach the lead assembly to a collar. The hook and jaw assembly may be located on the body of the collar attachment member. At least a portion of the jaw member may be received within the transverse channel located in the body of the collar attachment member, wherein in use, at least a portion of the jaw member pivots into and out of the transverse channel between the open condition and the closed condition relative to the hook member.

The hook and jaw assembly may be biased into a closed condition. The hook and jaw assembly may be biased into a closed condition by a spring member.

The collar attachment member may have an attachment point located thereon. The attachment point may be located on the hook and jaw assembly, optionally on the jaw member of the hook and jaw assembly. The attachment point may be located on the end of the jaw member opposing the jaw.

The attachment point may be of any suitable type sufficient to substantially preclude movement of the jaw member relative to the body preventing the collar attachment member from being released from the collar. The attachment point may be a projection extending outwardly from the jaw member, the projection comprising an aperture therein through which the lockable connector of the lead attachment member may pass in order to lock the collar attachment member. Attaching the lockable connector of the lead attachment member to the attachment point on the collar attachment member prevents the attachment point from moving into the transverse channel and locks the jaw member into the closed condition relative to the body.

The collar attachment member may further comprise a lock mechanism. The lock mechanism may be located in the body of the collar attachment member.

Any suitable lock mechanism may be used. In some embodiments, the lock mechanism may be a key lock mechanism, a combination lock mechanism, a biometric lock mechanism, or the like.

The collar attachment member may include a lock mechanism configured to selectively allow and/or substantially preclude movement of the jaw relative to the hook.

The lock mechanism may be used to lock the collar attachment member to the collar connector to prevent the collar attachment member from being released from the collar. In this instance, locking the collar attachment member to the collar connector prevents the removal of the lead assembly and/or the collar from the pet.

The lead attachment member may have a body connected to the proximal end of the elongate flexible member. The body of the lead attachment member may be provided with an end cap, wherein the end cap may be adapted for connection to the proximal end of the elongate flexible member. The end cap may be located on the end of the body opposing the lockable connector.

The end cap of the lead attachment member may comprise a first end and an opposed second end and a bore extending at least part way through the end cap from the first end to the opposing second end. The bore may extend all of the way through the end cap of the lead attachment member from the first end to the second end thereof. Thus, it is envisaged that the bore may comprise a pair of open ends, or one open and one closed end.

The body and the end cap of the lead attachment member may be fixedly, or moveably connected to one another. The body of the lead attachment member may be movably connected to the end cap, such that the body of the lead attachment member may move relative to the elongate flexible member. The body of the lead attachment may pivot relative to the end cap. Advantageously, allowing the body of the lead attachment member to move relative to the end cap allows access to the lock mechanism.

The end cap of the lead attachment member may be adapted for connection to the elongate flexible member by any suitable means sufficient to prevent the elongate flexible member from passing out of the lead attachment member. For instance, the size of the bore in the end cap may retain the elongate flexible member in frictional engagement therewith resulting from the pressure fit of the elongate flexible member within the bore. Alternatively, the end cap may be attached to the proximal end of the elongate flexible member using an adhesive. In other embodiments, the elongate flexible member may be adhered to the end cap using any suitable technique, such as a heat and/or a chemical treatment technique. Alternatively, the end cap may be attached to the proximal end of the elongate flexible member using a mechanical fastener such as, but not limited to screws, nails, bolts, pins, set or grub screws, rivets, or the like, or any suitable combinations thereof. In some embodiments, the end cap may be attached to the proximal end of the elongate flexible member, by a locking pin inserted at least partially into a locking pin bore located in the end cap and configured to engage with the proximal end of the elongate flexible member. In some embodiments, the locking pin may engage with an eye end of an embedded wire core of the elongate flexible member.

The lead attachment member may have a lockable connector configured for lockable attachment to the attachment point of the collar attachment member, thereby preventing the collar attachment member from being released from the collar. In other embodiments, the lead attachment member may be lockably attached to the collar, thereby preventing the lead attachment member from being released from the collar. The lockable connector may be located on the body of the lead attachment member.

The lockable connector may be a padlock, a hook and jaw assembly, a D-shackle, a locking pin, a hitch pin, or the like. In some embodiments, the lockable connector may be a hook and jaw assembly.

Where the lockable connector is a hook and jaw assembly, the lockable connector may be biased into a closed condition. The lockable connector may be biased into a closed condition by a resilient member such as a spring.

The lead attachment member may further comprise a lock mechanism. The lock mechanism may be located in the body of the lead attachment member. In some embodiments, the lead attachment member may be lockably attached to the lead assembly or the collar assembly. In this instance, it will be understood that a key, code or biometric profile which unlocks the lock mechanism is required to release the lead attachment member from the lead assembly or the collar assembly.

Any suitable lock mechanism may be used. In some embodiments, the lock mechanism may be a key lock mechanism, a combination lock mechanism, a biometric lock mechanism, or the like.

In some embodiments, the lock mechanism may be configured to selectively allow, and/or substantially preclude opening of the lockable connector. Where the lockable connector may be a hook and jaw assembly, the lock mechanism may substantially preclude movement of the jaw relative to the hook preventing the lockable connector from opening.

The lock mechanism may be used to lock the lead attachment member to the lead connector to prevent the lead attachment member from being released from the elongate flexible member. In this instance, locking the lead attachment member to the elongate flexible member maintains the integrity of the loop being used as a handhold.

The lock mechanism may be used to lock the lead attachment member to the collar attachment member to prevent the collar attachment member from being released from the collar. In this instance, locking the lead attachment member to the collar attachment member prevents the removal of the lead assembly and/or the collar from the pet.

In some embodiments, the lead attachment member and the collar attachment member may each be provided with a lock mechanism. In other embodiments, one of the lead attachment member and the collar attachment member may be provided with a lock mechanism.

In a second aspect, there is provided a collar assembly for a pet, the collar assembly comprising:
an elongate flexible strap having a first end and an opposed second end;
a clasp attached to the first end of the elongate flexible strap and configured to receive the second end of the strap, the clasp comprising:
   a housing having a cover positioned on the housing and pivotably moveable relative thereto to receive and hold the second end of the elongate flexible strap inside the housing, and
   a collar connector mounted about at least a part of the housing so as to define a locking aperture for receiving a locking member;
wherein movement of the collar connector relative to the clasp enables the cover to be moved between an open condition wherein the elongate flexible strap can be inserted into and/or removed from the clasp and a closed condition wherein the elongate flexible strap is prevented from being released from the clasp.

The collar assembly may be for any suitable pet. For instance, the collar assembly may be for a domestic animal such as a dog, a cat, a ferret, a rat, or the like, or for a livestock animal such as horses, cattle, sheep, goats, alpacas, or the like. In some embodiments described herein, the collar assembly may be for a dog

The elongate flexible strap has a first end and an opposed second end. The first proximal end of the strap may be adapted for connection to a clasp and the opposed second distal end of the strap may be configured to be inserted into and/or removed from the clasp in order to tighten or loosen the strap.

The elongate flexible strap may be substantially planar in configuration and may have a generally uniform cross-section along its length.

The elongate flexible strap may be fabricated from any material sufficient to provide a light, flexible but strong collar. For instance, the elongate flexible strap may be fabricated from a metal or metal alloy such as steel, aluminium, or the like, a polymeric material such as polypropylene, polyethylene, nylon or the like, a natural material such as leather, hemp, bamboo, a woven fabric, or any suitable combinations thereof.

The elongate flexible strap may be fabricated from two or more materials. The materials may be of the same type, or of different types. The materials may have the same properties, or have different properties. For instance, the materials may be relatively resistant to cutting, may be aesthetically pleasing, may be non-abrasive, may be durable, and/or may be water-resistant.

In embodiments wherein the elongate flexible strap is fabricated from two or more materials, the materials may be in any suitable orientation relative to one another. For instance, the elongate flexible strap may comprise a first material forming a core and substantially surrounded by a second material, the first material and the second material may be laminated together, the first material may be coated onto the second material, the first material and the second material may be woven together. The elongate flexible strap may comprise a first material forming a core and a second material substantially surrounding the first material.

The first material forming a core may be a reinforcing material. Any reinforcing material with sufficient mechanical properties strength, rigidity, durability, etc to provide the elongate flexible member with security against cutting and/or pulling may be used. In some embodiments, the first material may be a steel wire.

The second material forming an outer layer substantially surrounding the first material may be a flexible, durable strap material, such as leather, nylon webbing, or the like. The second material may be leather.

In some embodiments, the elongate flexible strap comprises at least one embedded wire core. The at least one embedded wire core may comprise diecast ends. A clasp may be attached to the first end of the elongate flexible strap about the diecast ends. Advantageously, providing the elongate flexible strap with an embedded wire core and connecting the clasp to the diecast ends connected to the wire core adds strength and security against cutting and pulling.

The collar assembly may comprise a clasp attached to the first end of the elongate flexible strap, configured to receive the second end of the strap therein. The clasp may comprise a housing having a cover positioned on the housing. The cover may be pivotably moveable relative to the housing to receive and hold the second end of the elongate flexible strap inside the housing.

The housing may include an upper body portion positioned on an upper surface of the first end of the elongate flexible strap and a lower body portion positioned on a lower surface of the first end of the elongate flexible strap, wherein the upper body portion and the lower body portion substantially encase the first end of the elongate flexible strap therein.

The upper body portion and lower body portion may each comprise one or more pairs of opposing apertures therein, each opposing aperture configured to receive a portion of a diecast end therein securing the clasp to the elongate flexible strap.

A rivet may be inserted through the upper body portion, the first end of the elongate flexible strap and the lower body portion to connect the upper and the lower body portions to one another to further secure the housing to the elongate flexible strap.

The collar assembly for a pet may further comprise at least one magnet which allows the cover to magnetically attach to the housing to close the clasp. The magnet may be located in the lower body portion of the housing.

The cover may be provided with a projection extending outwardly therefrom and configured to engage with a surface of the elongate flexible strap when the cover is in a closed condition. In some embodiments, the projection may engage with an aperture located in the elongate flexible strap to prevent the release of the strap if it is pulled. The projection may contact the at least one magnet located in the housing to magnetically attach the cover to the housing. The projection may form an obtuse angle relative to the direction of insertion of the flexible elongate strap into the clasp such that the projection may prevent the elongate flexible strap from being moved out of the clasp if a force is applied in the opposite direction.

The clasp may comprise a collar connector mounted about at least a part of the housing so as to define a locking aperture for receiving a locking member. The collar connector may be mounted about the upper body portion of the housing.

The collar connector may be pivotally mounted to the housing, wherein movement of the collar connector relative to the housing enables the cover to be moved between an open condition wherein the elongate flexible strap may be inserted into and/or removed from the clasp and a closed condition wherein the elongate flexible strap may be prevented from being released from the clasp. Attaching the locking member to the collar connector may preclude opening of the cover relative to the housing, thereby preventing the elongate flexible strap from being released from the clasp.

Any suitable collar connectors may be used, such as D-rings, loops, or the like. Attaching the locking member to the collar connector may prevent the elongate flexible strap from being released from the clasp.

In some embodiments, the collar connector may be mounted about at least a part of the housing. Where the collar connector is mounted on the clasp of the collar, attaching the locking member to the collar connector may preclude opening of the cover relative to the housing, thereby preventing the elongate flexible strap from being released from the clasp.

When the locking member is attached to the collar connector, movement of the collar connector relative to the clasp may be restricted. Movement of the collar connector relative to the clasp may be restricted by any suitable means. The collar connector may be physically sized such that when the locking member is attached, it obstructs movement of the collar connector. The locking member may lock the collar connector to the clasp preventing movement of the collar connector.

The locking member may be of any suitable type. For instance, the locking member may be a padlock, a hook and jaw assembly, a D-shackle, a locking pin, a hitch pin, or the like.

In some embodiments, the locking member may be a collar attachment member according to the first aspect. In other embodiments, the locking member may be a lead attachment member according to the first aspect.

In some embodiments, the collar connector on the collar is configured for attachment to the lead assembly according to the first aspect.

In a third aspect, there is provided a safety assembly for securing a pet, the safety assembly comprising a lead assembly according to the first aspect lockably connectable to a collar assembly according to the second aspect, preventing removal of the lead assembly and/or the collar assembly from the pet.

An identification tag may be attached to the collar. The identification tag may be attached to any suitable portion of the clasp and/or any suitable portion of the elongate flexible strap. For instance, the identification tag may be attached to a belt loop associated with the collar, the housing of the clasp, or the collar connector of the clasp.

In another aspect there is provided a lead assembly for a pet, the lead assembly comprising:
an elongate flexible member having a distal end and a proximal end and at least one attachment point located along the length of the elongate flexible member;
a collar attachment member having a body connected to the distal end of the elongate flexible member and a hook and jaw assembly configured to releasably attach the lead assembly to a collar, the collar attachment member having at least one attachment point located thereon;
a lead attachment member having a body connected to the proximal end of the elongate flexible member and a hook and jaw assembly configured for lockable attachment to the at least one attachment points located on the elongate flexible member and/or the collar attachment member,
wherein when the lead attachment member is attached to the at least one attachment point located on the elongate flexible member, a loop is formed in the elongate flexible member for use as a handhold, and
wherein when the lead attachment member is attached to the least one attachment point located on the collar attachment member, the lead attachment member prevents the collar attachment member from being released from the collar.

In another aspect there is provided a collar assembly for a pet, the collar assembly comprising:
an elongate flexible strap having a first end and an opposed second end and at least one attachment point located along the length of the elongate flexible strap;
a clasp attached to the first end of the elongate flexible strap, the clasp comprising:
a housing including an upper body portion positioned on an upper surface of the elongate flexible strap and a lower body portion positioned on a lower surface of the elongate flexible strap, wherein the upper body portion and the lower body portion substantially encase the first end of the elongate flexible strap therein;
a cover positioned on the housing and pivotably moveable relative thereto, wherein at least a portion of the second end of the elongate flexible strap is held in frictional engagement between the upper body portion and the cover and is released when the cover is pivoted relative to the upper body portion to open the clasp, and
an attachment point mounted to the upper body portion and moveable relative to the clasp;
wherein movement of the attachment point relative to the clasp enables the cover to be moved between an open condition wherein the elongate flexible strap can be inserted into and/or removed from between the upper body portion and the cover and a closed condition wherein the elongate flexible strap is prevented from being released from the clasp.

Throughout this specification the word “comprise” or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Embodiments of the disclosure are now described by way of example with reference to the accompanying drawings in which:

FIG. 1 illustrates an embodiment of a lead assembly.

FIG. 2 illustrates an embodiment of an elongate flexible member of a lead assembly.

FIG. 3 illustrates an embodiment of a lead attachment member.

FIG. 4 illustrates an exploded view of the lead attachment member illustrated in FIG. 3.

FIG. 5 illustrates a cross section of the lead attachment member illustrated in FIG. 3.

FIG. 6 illustrates an embodiment of a collar attachment member.

FIG. 7 illustrates an exploded view of the collar attachment member illustrated in FIG. 6.

FIG. 8 illustrates an embodiment of a collar attachment member.

FIG. 9 illustrates an embodiment of a collar assembly.

FIG. 10 illustrates an exploded view of the collar assembly as illustrated in FIG. 9.

FIG. 11 illustrates an exploded side perspective view of the collar assembly as illustrated in FIG. 9.

FIG. 12 illustrates a cross-section of the collar assembly as illustrated in FIG. 9.

FIG. 13 illustrates a cross-section of the collar assembly as illustrated in FIG. 9.

FIG. 14 illustrates an embodiment of a lead attachment member attached to an attachment point located on the collar attachment member.

FIG. 15 illustrates an embodiment of a lead attachment member attached to a connector located on the elongate flexible member.

In the drawings, like reference numerals designate similar parts.

### DETAILED DESCRIPTION

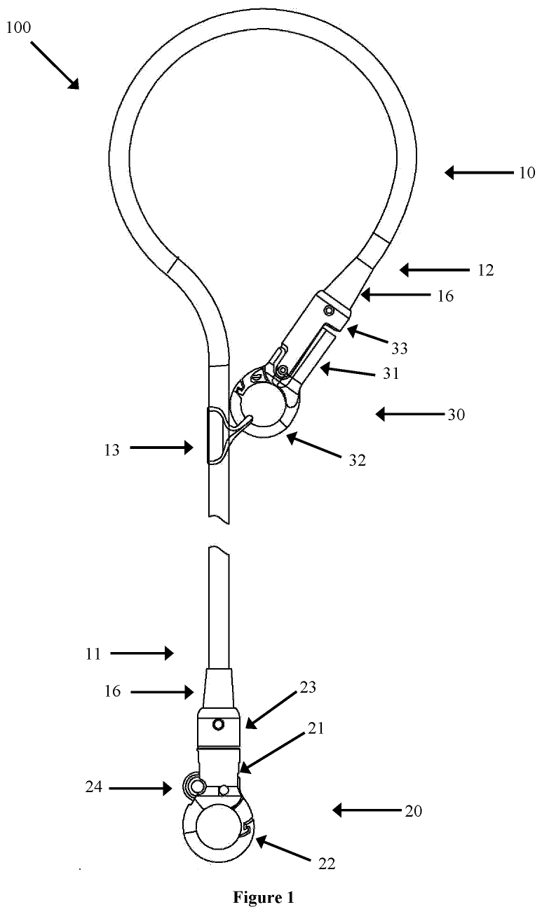

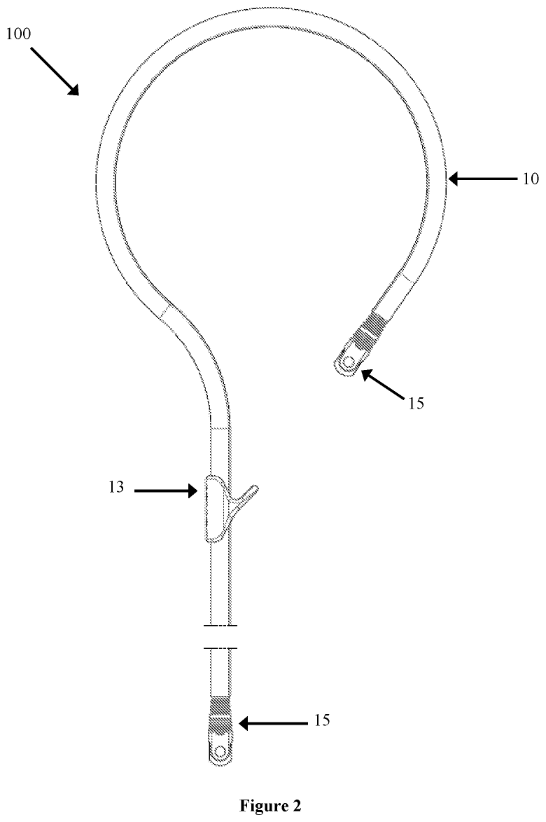

FIGS. 1 and 2 show a lead assembly 100 for a pet, such as a dog or a cat. The lead assembly 100 comprises an elongate flexible member 10 having a distal end 11 and a proximal end 12; a collar attachment member 20 configured to releasably attach the lead assembly 100 to a collar; and a lead attachment member 30 configured for lockable attachment to an attachment point 24 of the collar attachment member 20, thereby preventing the collar attachment member 20 from being released from the collar. The attachment point 24 is provided by a locking connector, in this embodiment in the form of a connecting aperture provided by a loop or ring.

The elongate flexible member 10 comprises at least one lead connector 13 located along the length of the elongate flexible member 10. When the lead attachment member 30 is attached to the lead connector 13, a loop is formed in the elongate flexible member 10 for use as a handhold. In alternative embodiments, the lead includes a conventional handle, and the lead attachment member 30 is provided along the length of the flexible member of the lead for example halfway up the lead, or adjacent the handle, or on the handle, so that the lead can be positioned around an anchor point such as a fence or lamp post, and the lead attachment member 30 is connected to the collar attachment member 20 via the lockable connector 32.

An alternative embodiment of a lead connector 13 is illustrated in FIG. 15 of the drawings, where the lead attachment member 30 is attached to a connector 13 in the form of a loop.

In some embodiments, the elongate flexible member 10 may comprise a strengthening component, such as one or more embedded wire cores. In these embodiments, at least one of the one or more embedded wire cores may comprise an eye end 15 as illustrated in FIG. 2 of the drawings. The lead attachment member 30 and the collar attachment member 20 may be attached to respective ends of the elongate flexible member 10 via an eye end 15.

As can be understood with reference to FIGS. 1 and 6 of the drawings, the collar attachment member 20 has a body 21 connected to the distal end 11 of the elongate flexible member 10 that supports a hook and jaw assembly 22,29 configured to releasably attach the lead assembly 100 to a collar. The collar attachment member 20 has a locking connector that provides an attachment point 24. The attachment point 24 is located on the hook and jaw assembly 22,29 of the collar attachment member 20 in such a way that attaching the lead attachment member 30 to the attachment point 24 substantially precludes movement of the jaw member 22 relative to the hook member 29, thereby preventing the collar attachment member 20 from being released from the collar.

As can be seen in FIG. 1 of the drawings, the lead attachment member 30 has a body 31 connected to the proximal end 12 of the elongate flexible member 100 that holds a lockable connector 32 configured for lockable attachment to the attachment point 24 of the collar attachment member 20, thereby preventing the collar attachment member 20 from being released from the collar.

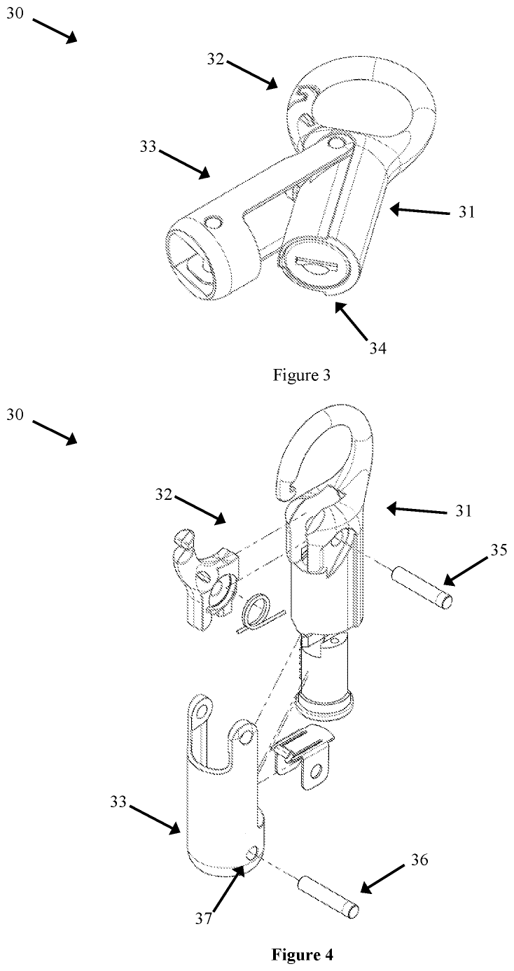

In FIGS. 3 to 5, a lead attachment member 30 for a lead assembly 100 is illustrated. The lead attachment member 30 has a body 31 and a lockable connector 32. The body 31 of the lead attachment member may comprise an end cap 33 to receive, hold, hide, cover, and/or protect the lock mechanism, as well as to connect the lead assembly 10 to the lead attachment member 30.

The lead attachment member 30 is connected to the elongate flexible member 10 by receiving and retaining at least a portion of the proximal end 12 of the elongate flexible member 10 within the body 31 of the lead attachment member 30, for example within the end cap 33 of the body 31 via an attachment means that includes one or more of glue, pressure fit, screws, studs, or the like.

In some embodiments the proximal end 12 may be retained within the lead attachment member 30 by at least one locking pin 36, the locking pin 36 inserted at least partially into a locking pin bore 37 located in the end cap 33 and configured to engage with the proximal end 12 of the elongate flexible member 10, substantially precluding the at least a portion of the distal end 12 from passing out of the lead attachment member 30. The portion of the proximal end 12 may be an embedded wire core of the elongate flexible member 10, for example an eye end of an embedded wire core 15.

The body 31 of the lead attachment member 30 is configured to pivot relative to the end cap 33 about pivot pin 35 to provide access to a lock mechanism 34 located in body 31.

The lockable connector 32 may include a hook and jaw assembly. The lockable connector may be biased into a closed condition. The lockable connector may be biased into a closed condition by a spring member.

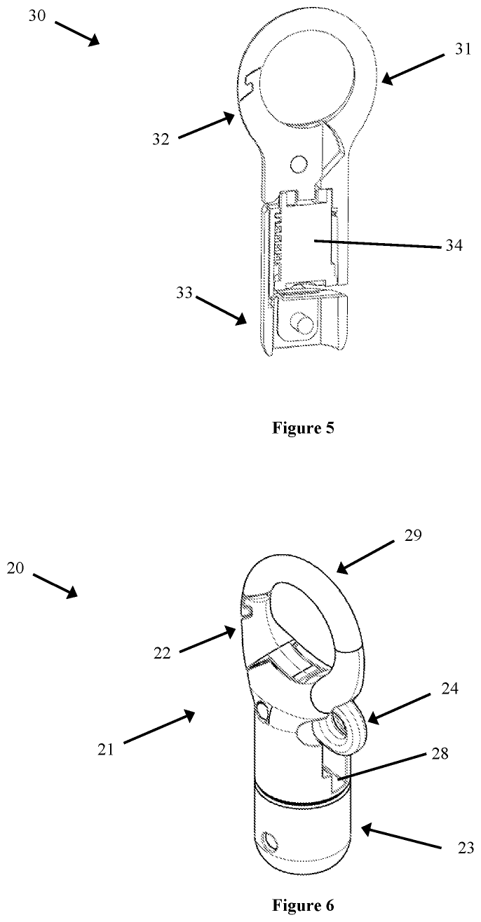

Referring to FIG. 5 of the drawings, a lock mechanism 34 is configured to selectively allow and/or substantially preclude opening of the lockable connector 32. Where the lockable connector 32 is a hook and jaw assembly, the lock mechanism 34 substantially precludes movement of the jaw relative to the hook, preventing the lockable connector 32 from opening.

In use, when the lead attachment member 30 is attached to the attachment point 24 of collar attachment member 20 it prevents the collar attachment member 20 from being released from the collar. In this instance, the lead attachment member 30 can be attached and removed from the attachment point at will, allowing an owner to tether their dog to a post so that it cannot run away.

To prevent the lead attachment member 30 from being removed from the attachment point 24, the pet owner may use a key to lock the lock barrel 34. Once the lock barrel 34 is in the locked position, the lockable connector 32 on the lead attachment member 30 can no longer be opened which prevents the lead attachment member 30 from being removed from the attachment point 24, thereby preventing the collar attachment member 20 from being released from the collar and so it follows that the collar strap cannot be released from the clasp, nor can the collar be removed from the dog.

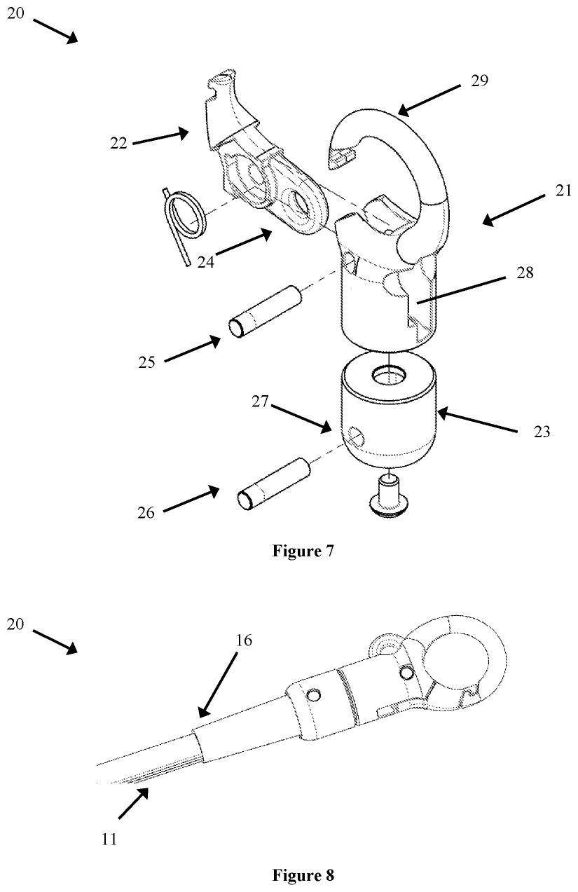

In FIGS. 6 to 8, a collar attachment member 20 for a lead assembly 100 is illustrated. The collar attachment member has a body 21 that supports a hook and jaw assembly 22,29. The collar attachment member 20 has a locking connector, that in the illustrated embodiment includes an attachment point 24 in the form of a locking aperture that is immobilised when a locking means is received in the locking aperture, thereby preventing the hook and jaw assembly 22,29 of the collar attachment member 20 from opening and being released from the collar.

The collar member body 21 of the collar attachment member 20 may comprise a transverse channel 28 therethrough, the transverse channel 28 configured to receive at least a portion of a jaw member 22 therein. Wherein in use, at least a portion of the jaw member 22 pivots into and out of the transverse channel 28 between the open condition and the closed condition relative to the hook member 29. The jaw member 22 has a first end and a second end, the first end comprising a jaw configured to abut the hook to close the collar attachment member 20. The second end comprises the attachment point 24, and when the jaw member 22 is in an open condition, the attachment point 24 moves into the transverse channel 28 as the jaw member 22 pivots relative to the hook member 29. Attaching the lead attachment member to the attachment point 24 prevents the attachment point 24 from moving into the transverse channel 28 and holds the jaw member 22 in the closed condition.

The body 21 of the collar attachment member 20 may have an end cap 23. The collar attachment member 20 is connected to the elongate flexible member 10 by receiving and retaining at least a portion of the distal end 11 of the elongate flexible member 10 within the body 21 of collar attachment member 20, for example within the end cap 23 of the body 21. The distal end 11 may be retained therein by at least one locking pin 26, the locking pin 26 inserted at least partially into a locking pin bore 27 located in the end cap 23 and configured to engage with the distal end 11 of the elongate flexible member 10, substantially precluding the at least a portion of the distal end 11 from passing out of the collar attachment member 20. The portion of the distal end 11 may be an embedded wire core of the elongate flexible member 10, for example an eye end 15 of an embedded wire core.

The hook and jaw assembly 22,29 may be biased into a closed condition. The hook and jaw assembly 22,29 may be biased into a closed condition by a spring member.

The hook and jaw assembly 22,29 has a connector for connecting the lead attachment member 30 to the collar attachment member 20. In the illustrated embodiment, the connector is a locking connector that includes an attachment point 24 configured to be connectable to the lockable connector 32 of the lead attachment member 30. Attaching the lockable connector 32 to the attachment point 24 substantially precludes movement of the jaw member 22 of the collar attachment member relative to the hook member 29, preventing the collar attachment member 20 from opening thereby preventing the collar attachment member 20 from being released from the collar.

As shown in FIG. 8 of the drawings, the ends of the elongate flexible member may be provided with a skirt 16 so as to prevent dirt and other debris from entering the collar attachment member and/or the lead attachment member, and/or to strengthen and support the interface between the flexible member and the collar attachment member 20.

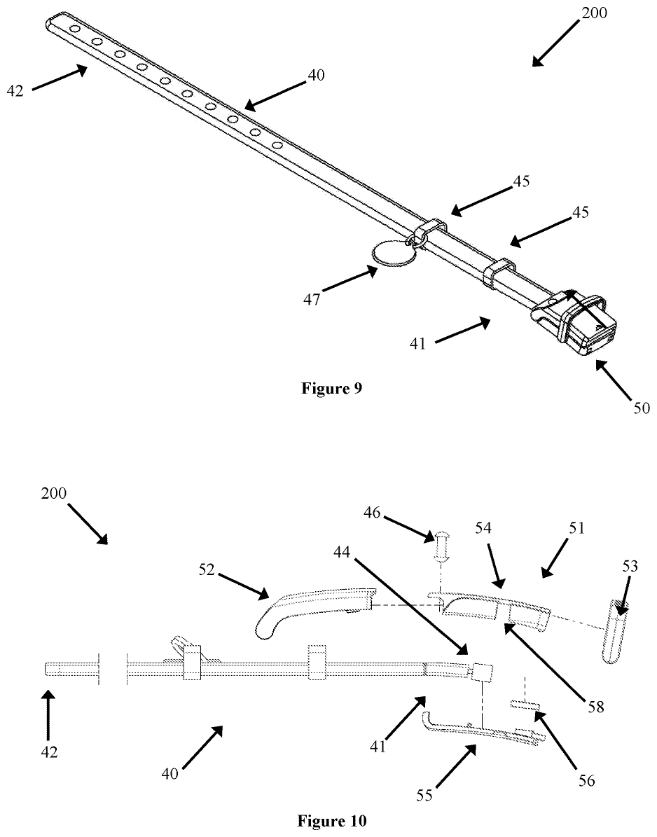

In FIGS. 9 to 13, a collar assembly 200 for a pet is illustrated. In alternative embodiments the collar assembly may be replaced with a harness assembly, for example with harness sections adapted to be positioned around the dog's chest and/or front legs, and the harness assembly including a clasp as described here with reference to the collar assembly. The collar assembly comprises an elongate flexible strap 40 that has a first end 41 and an opposed second end 42, and a clasp 50 attached to the first end 41 of the elongate flexible strap and configured to receive the second end 42 of the strap 40. An identification tag 47 is attached to the housing 51 of the clasp 50. In an alternative embodiment, the identification tag 47 may be attached to a belt loop 45 on the elongate flexible strap 40.

In some embodiments, the elongate flexible strap 40 is strengthened or reinforced, for example to make it harder to cut through, damage or remove the collar. To this end, the elongate flexible strap of the collar may, for example, comprise one or more embedded wire cores. At least one of the embedded wire cores may comprise a diecast end 44 as can be seen in FIG. 13 of the drawings. The clasp 50 may be attached to the first ends of the elongate flexible strap 40 about the diecast end 44.

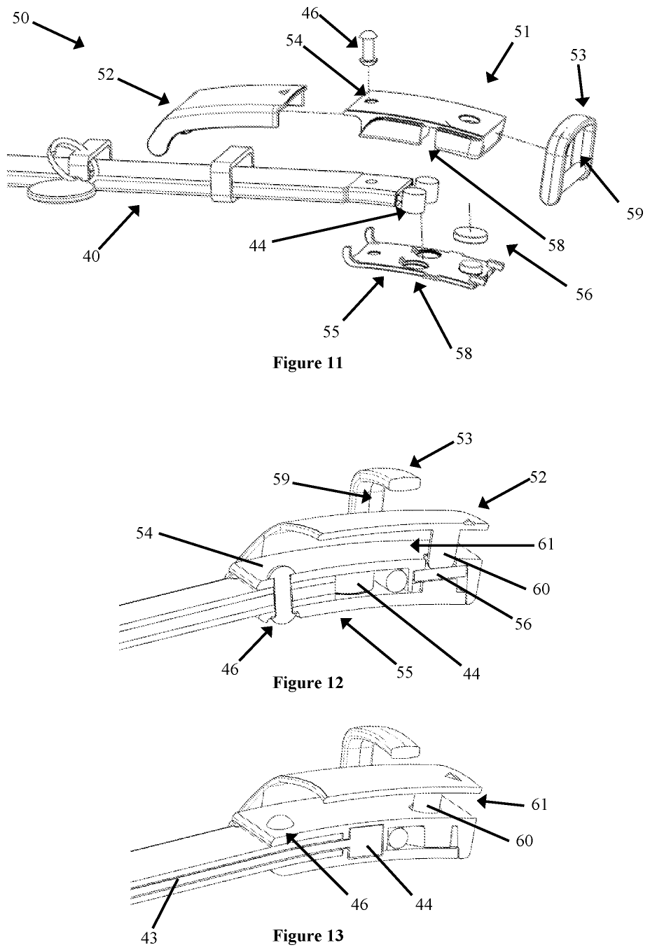

As best seen in FIG. 11 of the drawings, the clasp 50 may comprise a housing 51 having a cover 52 positioned on the housing 51 and pivotably moveable relative thereto to receive and hold the second end 42 of the elongate flexible strap 40 within a passageway 61 formed between the cover 52 and the housing 51. The clasp may also include a collar connector 53 mounted about at least a part of the housing 51 so as to define a locking aperture 59 for receiving a locking member, in this embodiment being the hook and jaw assembly 22,29 of the collar attachment member 20. Movement of the collar connector 53 relative to the clasp 50 enables the cover 52 to be moved between an open condition wherein the elongate flexible strap 40 can be inserted into and/or removed from the clasp 50 and a closed condition wherein the elongate flexible strap 40 is prevented from being released from the clasp 50.

When the collar attachment member 20 is attached to the collar connector 53 by positioning the hook and jaw assembly 22,29 in the locking aperture 59, movement of the cover 52 relative to the clasp 50 is substantially precluded. The collar connector 53 may be physically sized such that when the collar attachment member 20 is attached, movement of the collar connector 53 is obstructed thereby preventing opening of the clasp 50 and the release of the strap 40 from the clasp 50.

The housing 51 may include an upper body portion 54 positioned on an upper surface of the first end of the elongate flexible strap 40 and a lower body portion 55 positioned on a lower surface of the first end of the elongate flexible strap 40, wherein the upper body portion 54 and the lower body portion 55 substantially encase the first end 41 of the elongate flexible strap 40 therein.

The upper body portion 54 and lower body portion 55 may each comprise one or more pairs of opposing apertures therein, each opposing aperture 58 configured to receive a portion of a diecast end 44 therein to secure the clasp 50 to the elongate flexible strap 40. In some embodiments, the aperture may extend at least partially through the body portion, such that the aperture forms an open end and a closed end, In this embodiment, the closed end of the aperture provides a smooth finish on an outer surface of the body portion. In other embodiments, the aperture may extend through the body portion from one surface to the other surface, such that the aperture forms a pair of opposing openings on the surfaces of the body portion.

A rivet 46 can be inserted through the upper body portion 54, first end 41 of the elongate flexible strap 40 and lower body portion 55 to connect the upper and the lower body portions to one another to further secure the housing 51 to the elongate flexible strap 40.

In some embodiments, the collar assembly may include one or more magnets 56 which allow the cover 52 to magnetically attach to the housing 51 to close the clasp 50. The magnet/s 56 may be located in the lower body portion 55 of the housing 51.

As can be seen in FIG. 12 of the drawings, in the illustrated embodiment the cover 52 is provided with a projection 60 extending towards the lower body portion therefrom and configured to engage with a surface of the elongate flexible strap 40 when the cover 52 is in a closed condition. In some embodiments, the projection 60 may engage with an aperture located in the elongate flexible strap 40 to prevent the release of the strap if it is pulled; in other embodiments a separate mechanism such as a pin or rivet is used to secure the strap. The projection may contact the at least one magnet located in the housing to magnetically attach the cover to the housing.

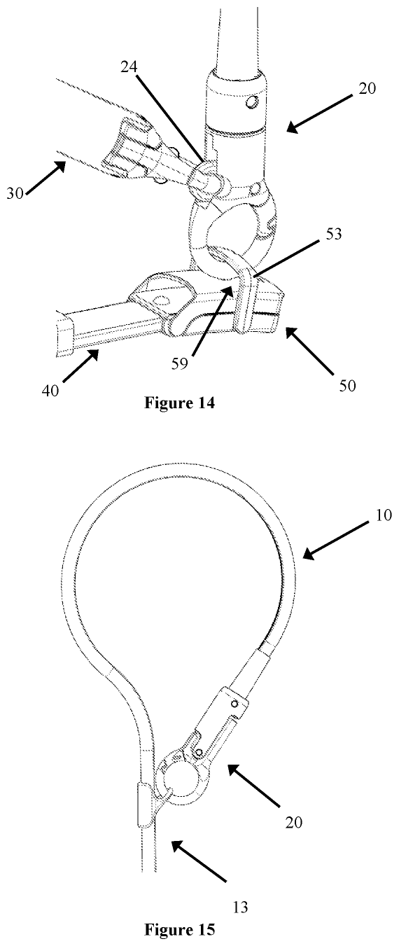

In FIG. 14, a lead attachment member 30 attached to an attachment point 24 on the collar attachment member 20 is shown. Attaching the lead attachment member 30 to the attachment point 24 of the collar attachment member 20 prevents the lockable connector 32 from opening and therefore from being detached from the collar connector 53. Attaching the collar attachment member 20 to the collar connector 53 may preclude movement of the collar connector 53 relative to the clasp 50 thereby preventing the elongate flexible strap 40 from being released from the clasp 50. Locking the lock mechanism in the lead attachment member 30 prevents the unauthorised removal of the lead from the collar of the pet and/or the collar from the pet.

Advantageously, the lead and collar combination described herein do not require any secondary components to keep the collar securely on the pet. Furthermore only one key lock in the system enables the locking of all three assemblies, effectively securing the pet via one locking action. The one key lock is at the proximal end of the leash, minimising the size and weight of components at the distal end, making the design lighter with less burden on the animal's neck. Also, because the locking mechanism is on the lead and not on the collar, the collar can be used without the lead; again, this places less burden on the animal's neck as the collar remains lightweight and functional without any part of the locking mechanism (i.e., the attachment member 20) forming part of the collar. Furthermore, the mechanism is relatively simple, with few moving parts and minimum components. This makes for a more cost efficient design, as well as a more robust mechanism, less prone to fault, jamming, wear and tear, or other damage. In contrast, in prior art lead and collar combinations, several separate components result in a combination that is less user-friendly. For example, where a separate lock (e.g., a padlock or locking carabiner) is used to connect a lead to a collar, the intermediate component can get lost or may not be properly sized. Furthermore, such additional components place an additional burden on the animal by adding weight to the collar area so that the additional weight needs to be carried by the animal's neck. This is particularly problematic for a small animal, and also if the locking mechanism forms part of the collar.

Prior art solutions include complex locks, for example having two eye portions in a locking mechanism that need to be aligned before they can be secured with an additional, separate lock. In contrast, the assembly described herein is very simple, with a jaw and hook mechanism that has the dual function of attaching the lead to the collar as well as locking the lead when required.

Advantageously, the lead connector mechanism is simple, meaning less moving parts, a simpler and more cost efficient construction, and less opportunity for malfunction or damage. In contrast, prior art lead connections often require two separate locking mechanisms to lock the lead to the collar as well as to lock the lead in a closed “tied up” configuration when a pet tied to an object. Such double-lock solutions are costly, heavy, and inefficient.

It will be understood to persons skilled in the art of the invention that many modifications may be made without departing from the spirit and scope of the invention.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Any promises made in the present description should be understood to relate to some embodiments of the invention and are not intended to be promises made about the invention as a whole. Where there are promises that are deemed to apply to all embodiments of the invention, the applicant/patentee reserves the right to later delete them from the description and does not rely on these promises for the acceptance or subsequent grant of a patent in any country.

1-25. (canceled)

26. A locking assembly for use with a lead for a pet, the locking assembly comprising:
a collar attachment member having: a collar member body configured for connection to a distal end of an elongate flexible member, wherein the elongate flexible member forms the lead, a locking member supported by the collar member body and configured to releasably attach the lead to a collar, and a locking connector located on the locking member; and
a lead attachment member having: a lead member body connected to a proximal end of the elongate flexible member, and a lockable connector configured for lockable attachment to the locking connector of the collar attachment member, thereby preventing the collar attachment member from being released from the collar.

27. The locking assembly according to claim 26,
wherein the locking member comprises a hook and jaw assembly, and the locking member comprises an attachment point,
wherein the attachment point of the collar attachment member is located on a jaw member of the hook and jaw assembly of the collar attachment member, and
wherein attaching the lead attachment member to the attachment point substantially precludes movement of the jaw member relative to the body to hold the jaw member in a closed condition relative to the body.

28. The locking assembly according to claim 26,
wherein the collar member body further comprises a transverse channel therethrough, the transverse channel configured to receive at least a portion of the locking member therein, and
wherein attaching the lead attachment member to the locking connector prevents the locking connector from moving into the transverse channel so that the locking member is held in a closed condition relative to the body.

29. The locking assembly according to claim 26, wherein the lead attachment member includes a lock mechanism configured to selectively allow or substantially preclude opening of the lockable connector.

30. The locking assembly according to claim 26, further comprising:
a clasp configured for attachment to a first end of an elongate flexible strap and configured to receive and hold a second end of the strap, wherein the strap forms the collar, the clasp comprising:
a housing having a cover positioned on the housing and pivotably moveable relative thereto to receive, when in an open position, and hold, when in a closed position, the second end of the elongate flexible strap inside the housing, and
a collar connector mounted about at least a part of the housing so as to define a locking aperture for receiving the collar attachment member,
wherein the locking aperture allows the cover to move to an open condition wherein the elongate flexible strap can be inserted into or removed from the clasp; and
wherein attaching a locking member to the collar connector precludes opening of the cover relative to the housing, thereby preventing the elongate flexible strap from being released from the clasp.

31. The locking assembly of claim 30, wherein attaching a locking member to the collar connector blocks the locking aperture, thereby preventing the cover from moving within the locking aperture in order for the clasp to open for the elongate flexible strap to be released from the clasp.

32. The locking assembly according to claim 30, wherein attaching the collar attachment member to the collar connector substantially precludes movement of the collar connector relative to the clasp, thereby preventing the elongate flexible strap from being released from the clasp.

33. The locking assembly according claim 26, wherein the lockable connector comprises a hook and jaw assembly supported by the lead member body.

34. The locking assembly according to claim 26,
wherein the lead member body is provided with an end cap, wherein the lead member body is connected to the elongate flexible member via the end cap, and
wherein the lead member body pivots relative to the end cap to provide access to a lock mechanism located in the lead member body.

35. A locking assembly comprising:
a collar attachment member for a collar or a harness; and
a lead attachment member comprising a lockable connector,
wherein the collar attachment member comprises: a locking member; and a locking connector arranged relative to the locking member, and
wherein when the lead attachment member is attached to the collar attachment member via the locking connector, movement of the locking connector is prevented, thereby also preventing movement of the locking member between an open position and a closed position.

36. The locking assembly of claim 35, wherein when the lead attachment member is attached to the locking connector of the collar attachment member and the lockable connector is locked, both the lead attachment member and the collar attachment member are locked in a closed condition.

37. The locking assembly of claim 35, further comprising: a clasp comprising:
a housing having a cover positioned on the housing and pivotably moveable relative thereto to receive when in an open position, and hold when in a closed position, an end of a collar inside the housing, and
a collar connector mounted about at least a part of the housing so as to define a locking aperture for receiving a locking member,
wherein the locking aperture allows the cover to move to the open position for receiving or releasing the end of the collar; and
wherein attaching the locking member to the collar connector prevents movement of the cover within the locking aperture, thereby preventing the clasp from opening.
